(19) United States
(12) Patent Application Publication
(10) Pub. No.: US 2003/0055978 A1
(43) Pub. Date: Mar. 20, 2003

(54) Methods and systems for enabling outside-initiated traffic flows through a network address translator

(75) Inventor: Leonard Alan Collins, Carnation, WA (US)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(73) Assignee: Microsoft Corporation, Redmond, WA

(21) Appl. No.: 09/955,525

(22) Filed: Sep. 18, 2001

(51) Int. Cl. G06F 15/16

(52) U.S. Cl. 709/227

(57) ABSTRACT

Disclosed are methods according to which a local computing device enables remote devices to initiate traffic flows with it by sending messages addressed to the remote devices. If the local device is behind one or more NATs, the NATs intercept the messages and create address mappings between the local and remote devices. When the remote devices initiate traffic flows, the NATs use these pre-established mappings to send the traffic to the local device. Before sending the initial message, the local device discovers from which remote devices it wishes to accept traffic. In one discovery method, the devices each communicate with a directory service. The service records which devices are willing to communicate with which others and provides that information to the devices. Each device induces a NAT mapping by sending a message to the other. Once discovery is complete, traffic flows between the devices without going through the directory service.

### TECHNICAL FIELD

The present invention relates generally to computer communications, and, more particularly, to communications flowing through a Network Address Translator.

### BACKGROUND OF THE INVENTION

Ideally, each computing device connected to the Internet is assigned a unique network address within the public address space. The growth of Internet connectivity, however, has rapidly depleted the supply of public addresses. To compensate, many computing devices today do not have public addresses but are, rather, assigned private addresses outside the public address space. Having disparate address spaces leads to complications, however. For example, a device with a private address cannot send a message to a device with a public address unless the private address is first translated to some public address. Network Address Translators (NATs) automatically perform this translation by intercepting packets from the device with the private address (this device is said to be “behind” the NAT) and then replacing the device's private address in the packet header with the NAT's own public address. The packet is then sent along to the outside device with the public address. The NAT stores a mapping between the private address of the device behind the NAT and the public address of the device outside the NAT. When traffic arrives from the outside device addressed to the public address of the NAT, the NAT refers to this mapping and replaces its own public address in the packet header with the private address of the device behind the NAT. By way of this mapping, the device behind the NAT can both send traffic to and receive traffic from a device in the public address space.

The NAT translation scheme is based on the premise that the traffic flow is initiated by the computing device behind the NAT. The NAT must first set up the translation mapping before it can know how to handle traffic coming from the public network address space. Were a device in the public address space to attempt to initiate a traffic flow by sending a message to the public address of the NAT, then, upon receiving the message, the NAT would search for a translation mapping for the sender's public address but would not find one. The NAT would discard the message, and the traffic flow would fail. This problem is compounded when each device is behind its own NAT. In this case, neither device can initiate the traffic flow: while the NAT of the traffic flow initiator sets up its translation mapping, the NAT of the recipient does not have an appropriate mapping and discards the incoming message. The traffic never starts flowing. As NATs proliferate, this shortcoming impedes the spread of any service based on direct device-to-device connectivity such as instant messaging, file transfer, remote control and management, and on-line meetings.

A known approach to this problem avoids all direct device-to-device traffic. A central server is set up with a public network address. Because the address is public, every device can initiate a traffic flow with the central server. When two devices wish to communicate, each sends data to the central server, and the central server forwards the data on to its intended recipient. This approach can be very useful as long as the amount of data transferred is small and the latency requirements are lax, but in other cases the central server quickly becomes a traffic bottleneck. Setting up and running a central server is also quite expensive in terms of money and resources.

Another proposal sets up a signaling exchange between a computing device behind a NAT and the NAT. The device sends a message directly to the NAT. The message directs the NAT to set up a translation mapping in anticipation of an outside-initiated traffic flow. However, this approach has its own drawbacks. First, it forces the device to discover its NAT and to take the NAT's presence into account. Traditionally, devices did not need to know whether they sat behind a NAT: the NAT's operation was completely transparent. Second, because NATs operate automatically by intercepting traffic and then passing it along, no standard protocol exists to facilitate the signaling exchange with a NAT. Adding that capability greatly alters the architecture of a NAT, which has often been an uncomplicated, firmware-based device. These considerations are compounded if the device sits behind a chain of multiple NATs, some of which may be located far from it, such as at the facilities of the device's Internet Service Provider (ISP). The device may not be aware of all of these NATs and may not have any means or permissions to communicate directly with them.

What is needed is a NAT-transparent method for enabling traffic flows initiated outside of a NAT to flow through the NAT.

### SUMMARY OF THE INVENTION

The above problems and shortcomings, and others, are addressed by the present invention, which can be understood by referring to the specification, drawings, and claims. According to the methods of the present invention, a local computing device enables remote devices to initiate traffic flows with it by sending initial messages addressed to the remote devices. If the local device is behind a NAT, then the NAT intercepts the messages and creates address mappings between the local and remote devices. When the remote devices initiate traffic flows, the NAT, if any, uses these pre-established mappings to send the traffic to the local device.

Before sending the initial message, the local computing device discovers from which remote devices it wishes to accept traffic. This discovery method can take any of numerous forms. For example, the users of the devices can speak on the telephone and agree to communicate via their devices. Alternatively, the devices can each communicate with a directory service. The service records which devices are willing to communicate with which others and provides that information (such as a device's public address) to the devices. Each device then induces a NAT mapping by sending an initial message to the public address of the other. Once the discovery process is complete, the actual traffic flows directly from one device to the other without going through the directory service.

### BRIEF DESCRIPTION OF THE DRAWINGS

While the appended claims set forth the features of the present invention with particularity, the invention, together with its objects and advantages, may be best understood from the following detailed description taken in conjunction with the accompanying drawings of which:

FIG. 1a is a network schematic from the prior art showing two computing devices behind a NAT and one computing device outside the NAT;

FIG. 1b is a network flow diagram from the prior art showing a computing device behind the NAT of FIG. 1a initiating a traffic flow with the computing device outside the NAT;

FIG. 1c is a data table diagram from the prior art showing the NAT's translation mapping that facilitates the traffic flow of FIG. 1b;

FIG. 1d is a network flow diagram from the prior art showing that the computing device outside the NAT of FIG. 1a cannot initiate a traffic flow with a computing device behind the NAT;

FIG. 2 is a block diagram generally illustrating an exemplary computer system that supports the present invention;

FIG. 3 is a network flow diagram showing how, according to one aspect of the present invention, a computing device behind a NAT enables a computing device outside the NAT to initiate a traffic flow through the NAT;

FIGS. 4a through 4c are combination flowcharts and protocol diagrams showing the processing and messaging involved when a computing device behind a NAT communicates with a device outside the NAT;

FIG. 5 is a network flow diagram showing that the invention works even when the computing device is behind more than one NAT; and

FIG. 6 is a network flow diagram showing, according to one aspect of the present invention, a directory service that enables computing devices behind NATs to communicate directly with one another.

### DETAILED DESCRIPTION OF THE INVENTION

Turning to the drawings, wherein like reference numerals refer to like elements, the invention is illustrated as being implemented in a suitable computing environment. The following description is based on embodiments of the invention and should not be taken as limiting the invention with regard to alternative embodiments that are not explicitly described herein.

In the description that follows, the invention is described with reference to acts and symbolic representations of operations that are performed by one or more computing devices, unless indicated otherwise. As such, it will be understood that such acts and operations, which are at times referred to as being computer-executed, include the manipulation by the processing unit of the computing device of electrical signals representing data in a structured form. This manipulation transforms the data or maintains them at locations in the memory system of the computing device, which reconfigures or otherwise alters the operation of the device in a manner well understood by those skilled in the art. The data structures where data are maintained are physical locations of the memory that have particular properties defined by the format of the data. However, while the invention is being described in the foregoing context, it is not meant to be limiting as those of skill in the art will appreciate that various of the acts and operations described hereinafter may also be implemented in hardware.

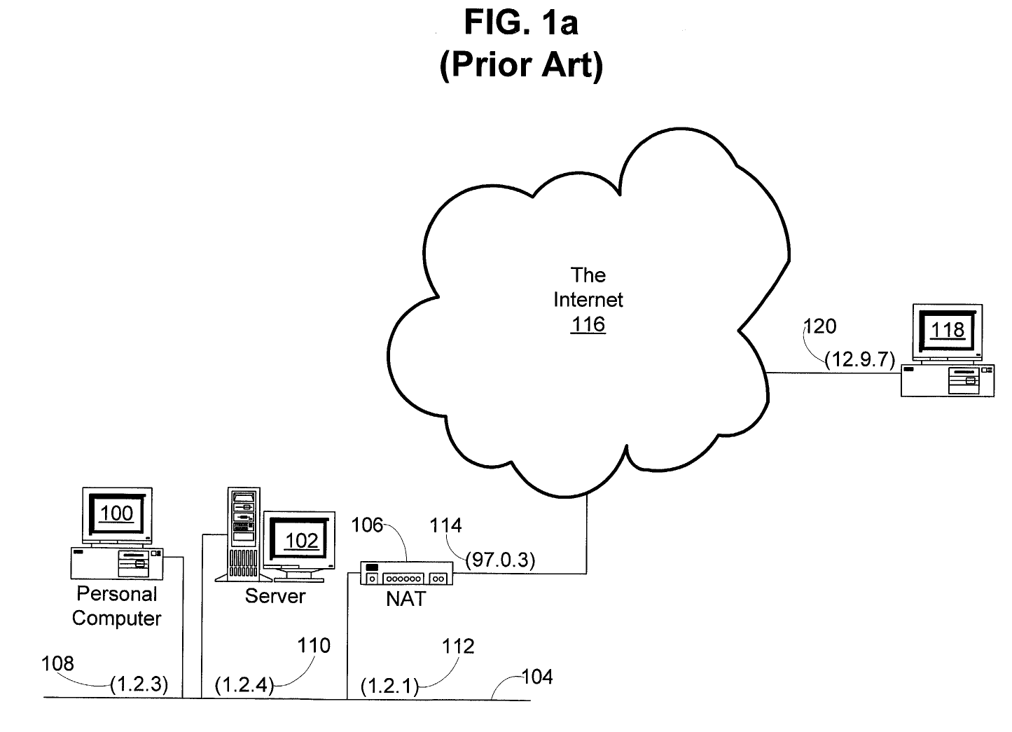

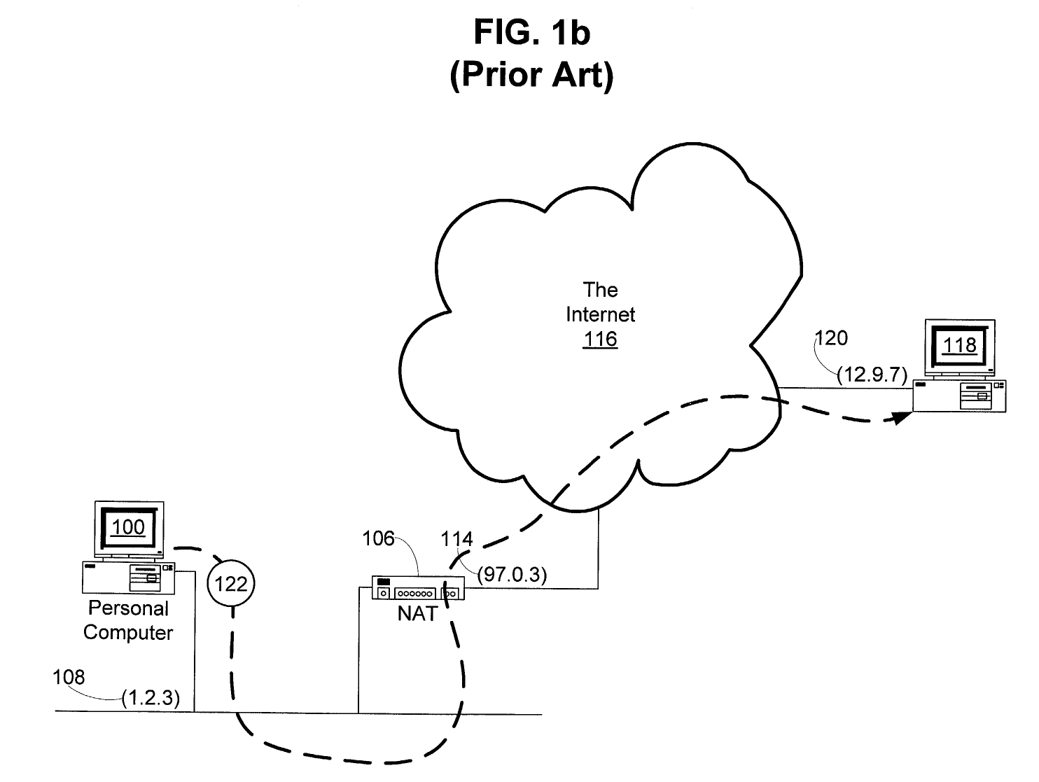

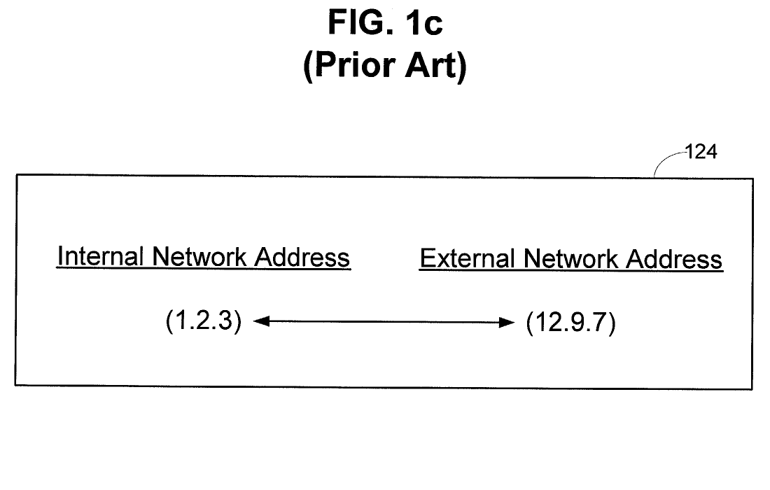

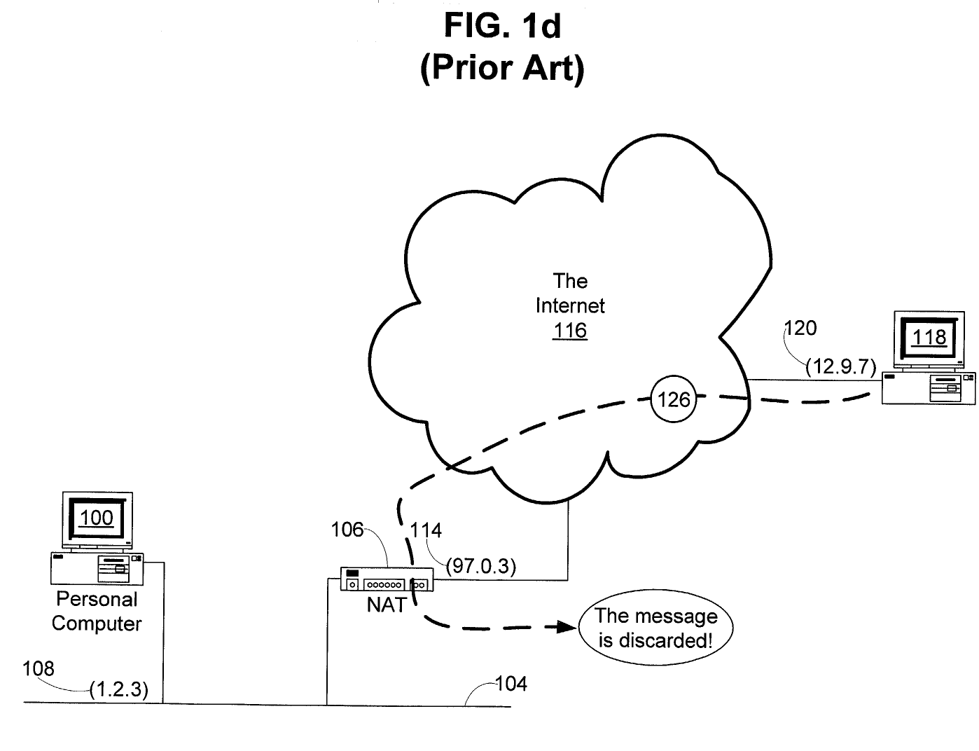

Although the present invention does not involve changes to NAT functionality, it is important to understand that functionality in order to understand the invention. FIG. 1a shows a prior art networking arrangement that is the basis for the following discussion of NATs and of the invention. In the Figure, two computing devices 100 and 102 are connected via a local area network (LAN) 104 to a NAT 106. The NAT also has a connection to a public address space, here represented by the Internet 116. The network addresses 108, 110, and 112 used on the LAN are private addresses, that is to say, they are not valid in the public address space beyond the NAT. Because of this, device 100 cannot communicate with a computing device 118 in the public address space unless the private address 108 of device 100 is first translated. The NAT is responsible for this translation, and the mechanism of translation is described below with respect to FIG. 1b. Unlike the first two devices 100 and 102, device 118 has a public network address 120 that needs no translation. Note that while Internet Protocol (IP) addresses are a standard for the industry, the example addresses (108, 110, 112, 114, and 120) are intentionally shown in a non-IP format to indicate that the invention is not limited to any particular addressing format.

FIG. 1b, also from the prior art, shows how NAT 106 facilitates computing device 100 in setting up a traffic flow with the computing device 118. As compared with FIG. 1a, FIG. 1b deletes several details for clarity's sake. Device 100 addresses an initial message to the public network address 120 of device 118. The initial message follows the path 122. Although the message is not addressed to the NAT, the NAT intercepts it and reads the “to address” field in the message's header. Because that field contains public network address 120, the NAT knows to send the message out on its connection to the Internet 116. However, the message as written by device 100 is not valid for the public address space because the “from address” field in the message's header contains the private network address 108 of device 100. The NAT replaces this private address with its own public address 114. The NAT also creates an address translation mapping that correlates the private network address of device 100 with the public network address of device 118. FIG. 1c shows this mapping in the translation table 124. Then, the NAT sends the altered initial message on its way. The initial message travels via the Internet 116 and is received by the destination device 118.

The message path 122 has an arrowhead at one end to indicate that it is the path for initiating a traffic flow between computing devices 100 and 118. That same path is traversed in the opposite direction by a response sent from device 118 to device 100 (although the exact path through the Internet 116 is immaterial). Device 118 addresses its response to the “from address” found in the header of the message it received. Because of the NAT's earlier translation, that address is actually the NAT's public address 114. When the NAT receives the response message, it searches its translation table 124 for the message's “from address” in the column pertaining to the interface over which the NAT received the message. The response message comes over the NAT's external network connection. In the “External Network Address” column of table 124 is an entry corresponding to the “from address” in the response message. Having found the appropriate address translation entry, the NAT removes its own external network address from the “to address” field of the message's header and substitutes for it the internal network address indicated by the mapping. In this case, that is (1.2.3), the address of device 100. In this manner, the NAT's address translation allows devices 100 and 118 to communicate with each other.

Computing devices 100 and 118 can communicate as long as the translation entry exists in the NAT's address translation table 124. For the sake of security and to preserve memory resources, the NAT does not store the translation mapping forever. Some NATs remove the translation after a period of inactivity. This timeout period may depend upon the type of the traffic and is typically on the order of hours for Transmission Control Protocol (TCP) traffic and minutes or seconds for User Datagram Protocol (UDP) traffic. Other NATs may monitor the traffic flow and discard the translation when one side or the other indicates that the conversation is over.

Note that the success of the NAT's translation scheme depends upon the fact that the computing device behind the NAT, here device 100, sends the initial message to initiate the traffic flow. FIG. 1d, again from the prior art, shows what happens when, instead, the computing device 118 attempts to initiate a traffic flow with device 100. Because the private network address 108 of device 100 is invalid in the public address space of the Internet 116, device 118 addresses its initial message to the public address 114 of NAT 106. This initial message follows the path 126. Just as when the NAT received the response message in the scenario of FIG. 1b, the NAT looks for an address translation mapping in its table 124. However, in the scenario of FIG. 1d the mapping shown in FIG. 1c does not exist because device 100 never sent a message through the NAT to device 118. Without the mapping, the NAT cannot translate the “to address” field in the message's header to a private network address on LAN 104. The message is discarded. Thus, in the prior art, a computing device outside of a NAT cannot initiate a traffic flow directly with a device behind the NAT. The problem is exacerbated when each computing device is behind its own NAT: then neither device can initiate a traffic flow with the other.

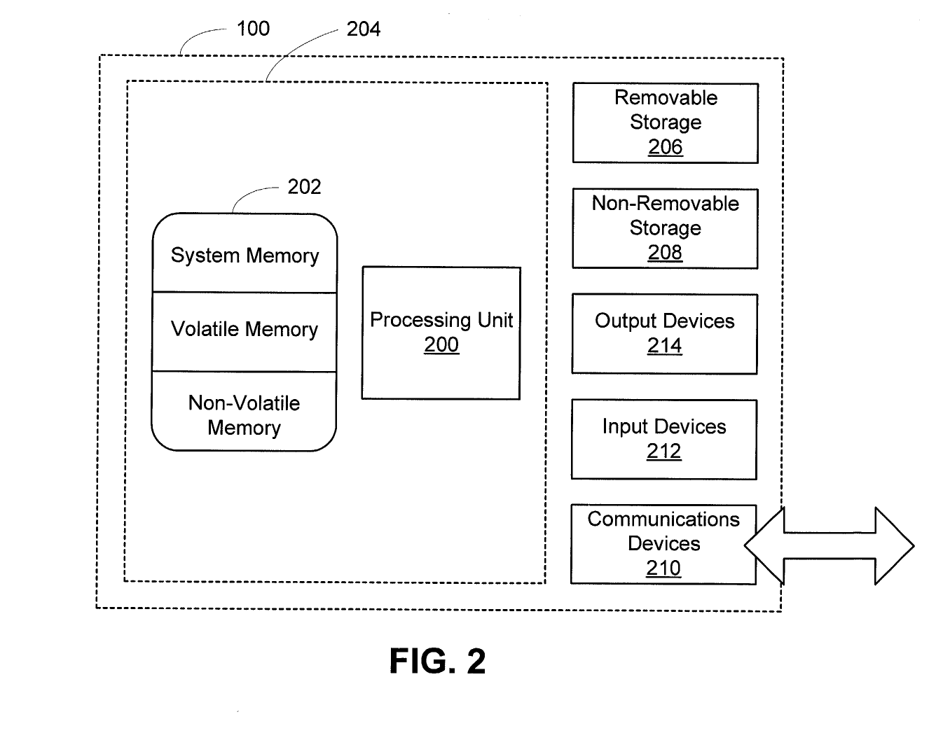

The computing devices 100, 102, and 118 of FIG. 1a may be of any architecture. FIG. 2 is a block diagram generally illustrating an exemplary computer system that supports the present invention. Computing device 100 is only one example of a suitable environment and is not intended to suggest any limitation as to the scope of use or functionality of the invention. Neither should computing device 100 be interpreted as having any dependency or requirement relating to any one or combination of components illustrated in FIG. 2. The invention is operational with numerous other general-purpose or special-purpose computing environments or configurations. Examples of well-known computing systems, environments, and configurations suitable for use with the invention include, but are not limited to, personal computers, servers, hand-held or laptop devices, multiprocessor systems, microprocessor-based systems, set-top boxes, programmable consumer electronics, network PCs, minicomputers, mainframe computers, and distributed computing environments that include any of the above systems or devices. In its most basic configuration, computing device 100 typically includes at least one processing unit 200 and memory 202. The memory 202 may be volatile (such as RAM), non-volatile (such as ROM, flash memory, etc.), or some combination of the two. This most basic configuration is illustrated in FIG. 2 by the dashed line 204. The computing device may have additional features and functionality. For example, computing device 100 may include additional storage (removable and non-removable) including, but not limited to, magnetic and optical disks and tape. Such additional storage is illustrated in FIG. 2 by removable storage 206 and non-removable storage 208. Computer-storage media include volatile and non-volatile, removable and non-removable, media implemented in any method or technology for storage of information such as computer-readable instructions, data structures, program modules, or other data. Memory 202, removable storage 206, and non-removable storage 208 are all examples of computer-storage media. Computer-storage media include, but are not limited to, RAM, ROM, EEPROM, flash memory, other memory technology, CD-ROM, digital versatile disks (DVD), other optical storage, magnetic cassettes, magnetic tape, magnetic disk storage, other magnetic storage devices, and any other media that can be used to store the desired information and that can be accessed by device 100. Any such computer-storage media may be part of device 100. Device 100 may also contain communications connections 210 that allow the device to communicate with other devices. Communications connections 210 are examples of communications media. Communications media typically embody computer-readable instructions, data structures, program modules, or other data in a modulated data signal such as a carrier wave or other transport mechanism and include any information delivery media. The term “modulated data signal” means a signal that has one or more of its characteristics set or changed in such a manner as to encode information in the signal. By way of example, and not limitation, communications media include wired media, such as wired networks (including LAN 104 of FIG. 1a) and direct-wired connections, and wireless media such as acoustic, RF, infrared, and other wireless media. The term “computer-readable media” as used herein includes both storage media and communications media. Computing device 100 may also have input devices 212 such as a keyboard, mouse, pen, voice-input device, touch-input device, etc. Output devices 214 such as a display, speakers, printer, etc., may also be included. All these devices are well know in the art and need not be discussed at length here.

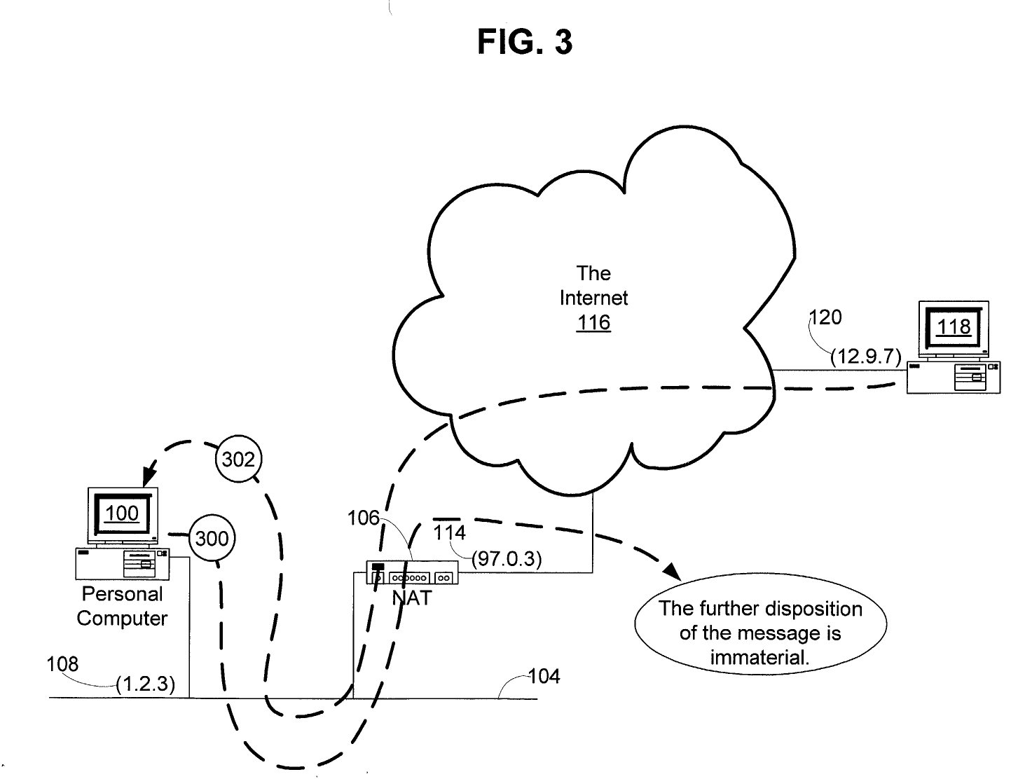

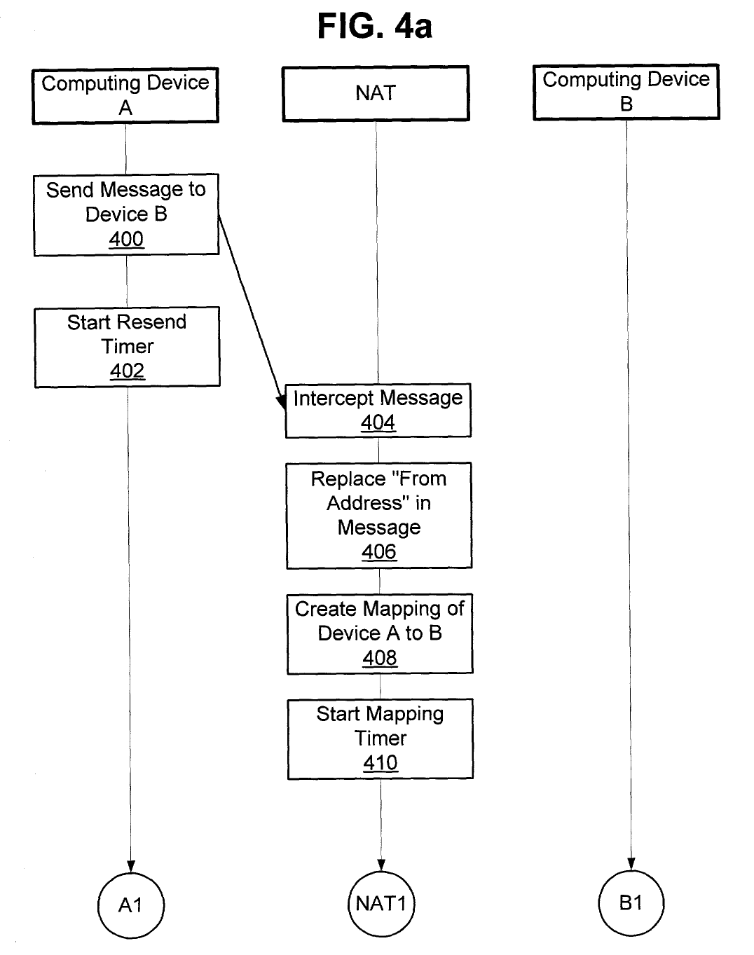

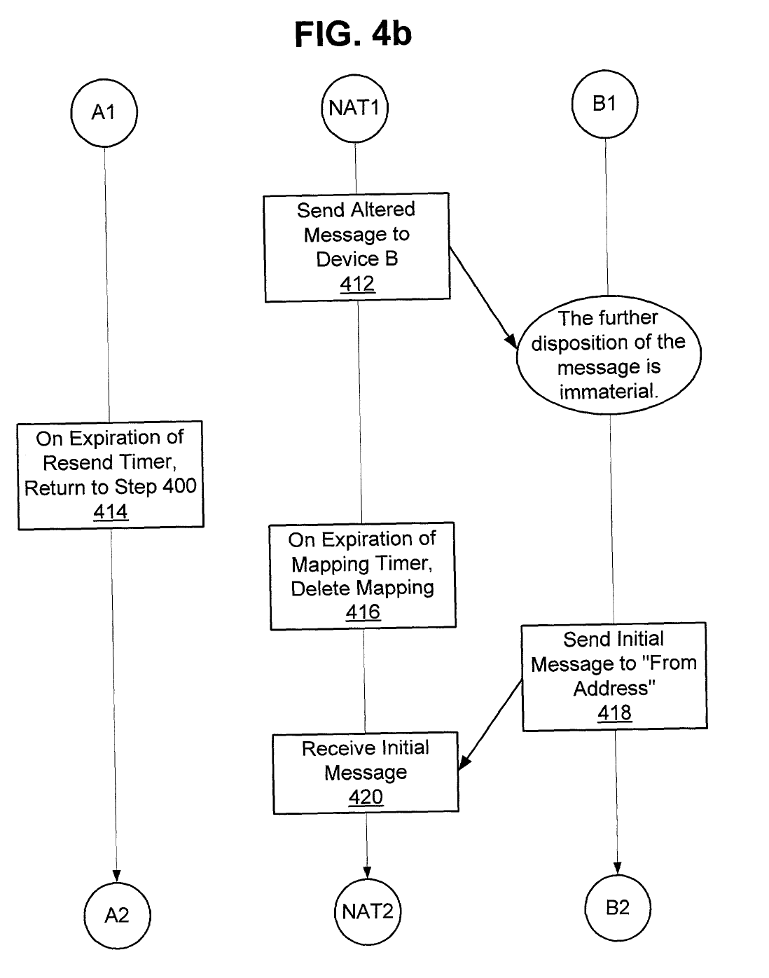

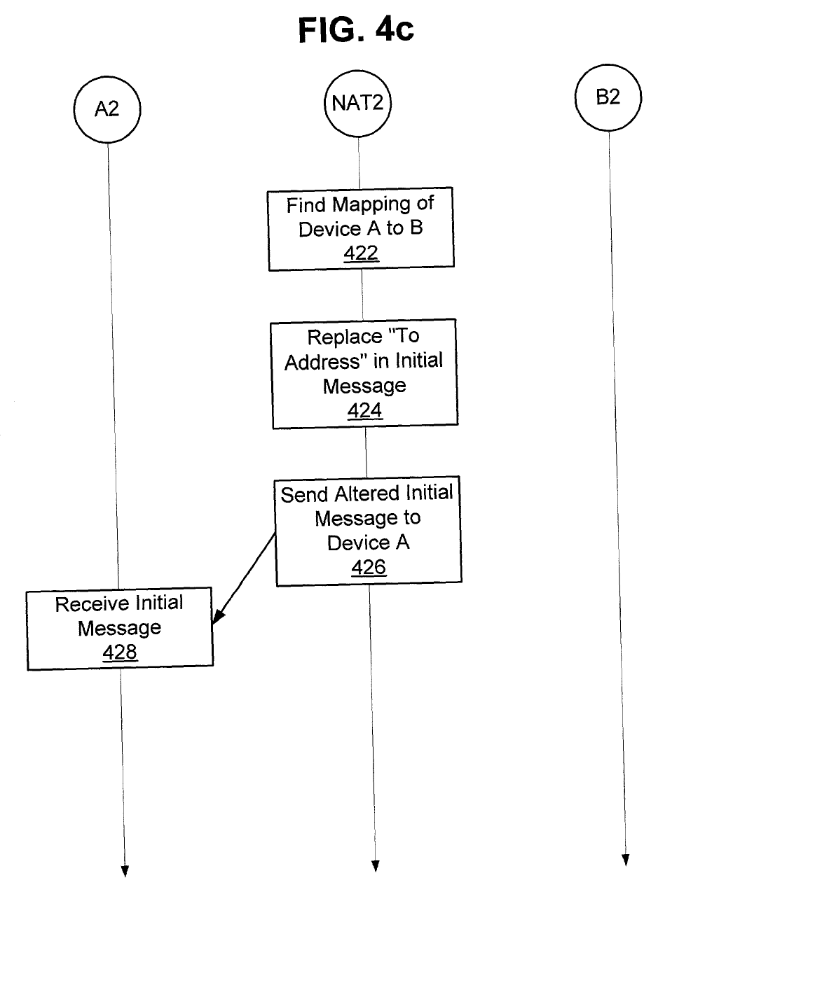

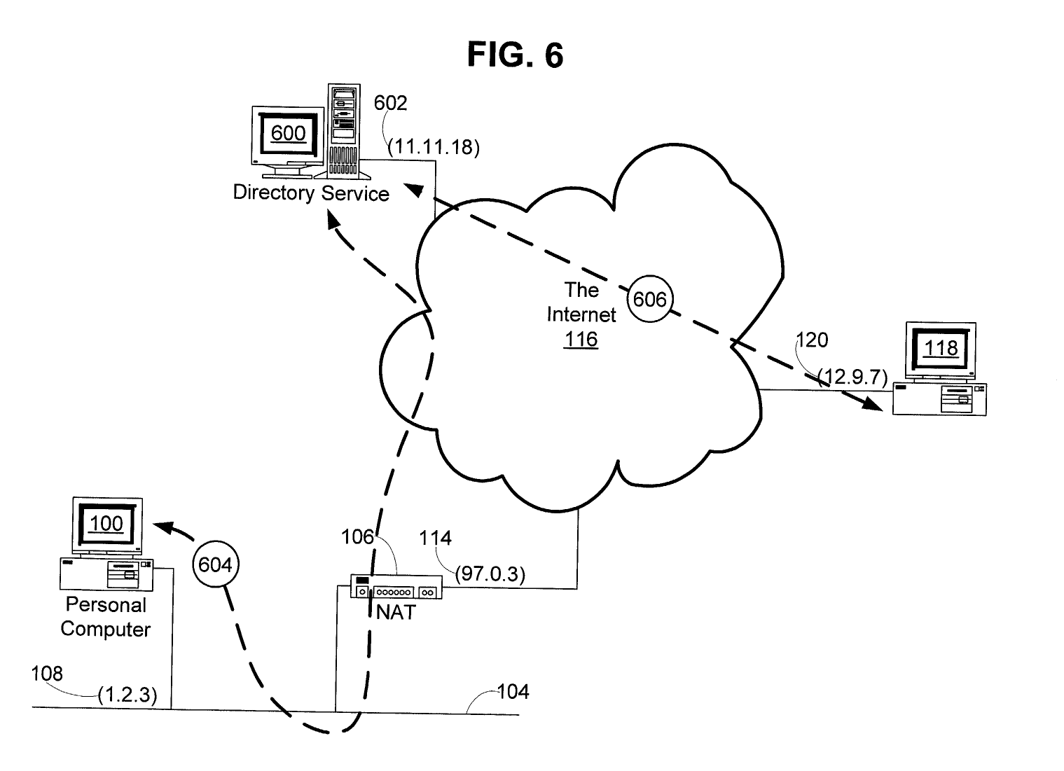

FIGS. 3 and 4a through 4c show how the present invention addresses the problem of NATs blocking outside-initiated traffic flows. The computing device 100 of FIG. 3 wishes to receive a traffic flow initiated by the computing device 118. The text accompanying FIG. 6 discusses how device 100 may decide that it wishes to receive such a traffic flow. According to one aspect of the invention, device 100 formulates a message addressed to device 118 and sends it in step 400 of FIG. 4a. This message follows path 300 of FIG. 3. At the same time, device 100 starts a resend timer in step 402. When the NAT 106 intercepts the message in step 404, it follows the same procedure as described with respect to FIG. 1b. The NAT replaces device 100's local network address 108 in the “from address” field of the message with the NAT's own public network address 114 in step 406. In step 408, the NAT sets up the address translation mapping shown in the table 124 of FIG. 1c. The NAT also starts, in step 410, a mapping timer so that it can discard the mapping after a prolonged period of non-use. (Note that some NATs may not implement a mapping timer.) The NAT sends the altered message in step 412 of FIG. 4b. Once the mapping is in place, the further disposition of the message is immaterial. The message may have a NULL content field and be discarded either in the network or upon arrival at device 118. If device 118 were behind its own NAT (not shown), then the message would certainly be discarded by that NAT. None of this matters as the only purpose of this message is to induce the NAT 106 to set up the address mapping between devices 100 and 118. In step 414, the resend timer expires, and device 100 sends another message (whose content is also immaterial) to keep this translation mapping alive on the NAT.

Now that the mapping is in place, computing device 118 is free to initiate traffic flow 302 of FIG. 3 with computing device 100. In step 418 of FIG. 4b, device 118 sends an initial message addressed to NAT 106 at its public network address 114. After receiving the message in step 420, the NAT, in step 422 of FIG. 4c, finds the mapping associated with messages received from device 118. As specified by the mapping, in step 424 the NAT replaces its own public network address 114 in the “to address” field of the message with the private network address 108 of device 100. The message is sent in step 426 to device 100. Device 100 has “punched a hole” through its own NAT, and device 118 is free to use that hole to initiate a traffic flow with device 100. The hole is specific to device 118 and cannot be used by any other computing device.

Note that the hole might also be specific to the type of protocol used when punching it. This follows from the fact that the NAT may maintain separate mappings for separate protocols, such as TCP and UDP. To be safe, device 100 should use the same protocol when punching the hole as it expects device 118 to use when communicating.

Note also that this procedure does not require the NAT to change its behavior in any way. The procedure does not present a security risk as only a computing device behind a NAT can induce the NAT to create a mapping. When device 100 sends the hole-punching message, it, in essence, “invites” remote device 118 to communicate with it. (Of course, the hole-punching message is not really an invitation because it need not reach the remote device.) No unauthorized incoming communications are enabled. Note finally that if the hole-punching message is harmless, e.g., has a NULL content field, then it is safe to practice this method regardless of whether device 100 is behind a NAT or not. The hole-punching procedure can be practiced automatically in a device's network communications stack, and applications can remain ignorant of whether they are behind a NAT or in the public address space.

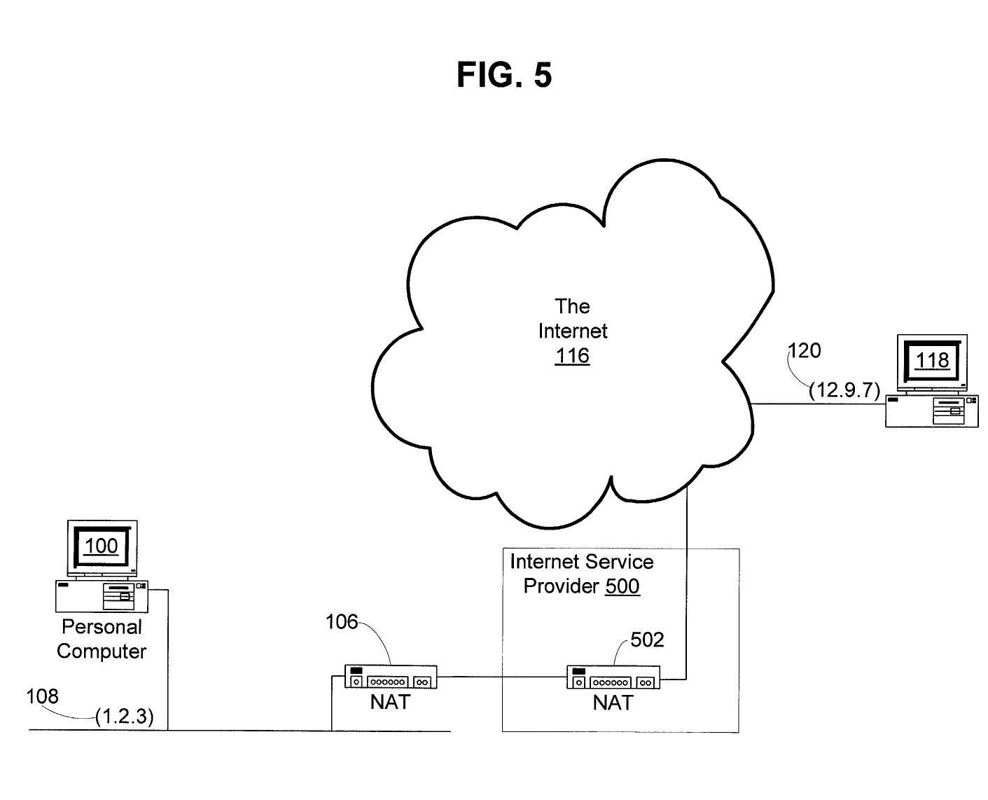

Finally note that this hole-punching procedure works in the more general case where a computing device sits behind more than one NAT. In FIG. 5, a business office uses a NAT 106 to share addresses among its computing devices, including device 100. The business office buys Internet connectivity from an ISP 500 that uses a NAT 502 to share addresses among its customers. All traffic from device 100 to and from the remote device 118 passes through both of these NATs. Each NAT independently creates its own translation mappings (as described above with respect to FIG. 1c), so that messages to and from device 100 may have their addresses changed by each NAT in turn. Even so, the invention works as described above with respect to FIGS. 3 and 4. The hole-punching message travels through successive NATs, inducing a mapping in each one. Once the message is processed by the “outermost” NAT, the one with a public address (in FIG. 5, this is NAT 502), the procedure is complete. Remote device 118 can use the series of holes by addressing a message to the public address of the outermost NAT. This procedure works even though the device 100 is unaware of the number of NATs between it and remote device 118, and even though device 100 probably would not have permission to communicate with these NATs if it knew of their existence.

In the discussion above, computing device 100 is assumed to know the address 120 of computing device 118 with which it wishes to communicate. FIG. 6 introduces some of the many possible ways for device 100 to discover that address 120. A directory service 600 has a public network address 602 so that any device can initiate a traffic flow with it. In one embodiment of the discovery method, device 100 sets up a traffic flow 604 with the directory service. Device 100 tells the directory service of a type of communication in which the device wishes to participate. For example, the device may request a computer-based video teleconference. The second device 118 similarly sets up a traffic flow 606 with the directory service and identifies a type of communication in which it is interested. The directory service compares the types, and when it finds a match, it tells each device the identity of its peer that wishes to communicate. The directory service may, for example, send a message to device 100 with the public address 120 of device 118. Having the address, device 100 either initiates a traffic flow with device 118 using the prior art technique of FIG. 1b or punches a hole through its NAT 106 using the technique of FIGS. 3 and 4a through 4c and allows device 118 to use the hole to initiate the traffic flow.

Because computing device 100 is behind a NAT 106, it has a private network address 108 that is not usable by the computing device 118. Thus, rather than sending that private address, the directory service 600 sends to device 118 the public address 114 of NAT 106. It may happen that each device is behind its own NAT (not shown). In that case, each device receives from the directory service the public address of its peer's NAT. When the first of the two devices attempts to initiate a traffic flow with the other, the initial message is discarded at the recipient's NAT because there is, as yet, no translation set up to handle it. However, the effort punches a hole through the first attempter's own NAT. Then, when the second device attempts to initiate a traffic flow, this second attempt succeeds, traversing the NAT of the first attempter by means of the already-set up translation. It does not matter which device is the first attempter so long as each device sends an initial message toward the other soon after it knows that it wishes to communicate with the other. The traffic flow is then initiated by whichever device is appropriate, given the nature of the communications application.

The directory service 600 of FIG. 6 may be used in another manner. Computing device 100 may already know the identity of its intended communications peer device 118 but not know its address. In this case, device 100 tells the directory service that it wishes to communicate with device 118. Directory service 600 contacts device 118 via message flow 606 and asks if it wishes to communicate with device 100. If so, then the directory service sends the address 120 to device 100. Device 100 punches a hole through its NAT 106 for use by device 118, and a traffic flow is initiated by whichever device is appropriate, given the nature of the communications application. Of course, if device 118 is behind its own NAT, then the directory service can only contact it if the message flow 606 has already been established or if device 118 has punched a hole through its NAT for use by the directory service. If device 118 is behind its own NAT, then, when it agrees to communicate with device 100, device 118 punches a hole through its NAT for use by device 100.

For the sake of clarity, the discussion so far simplifies the workings of a typical NAT. A NAT operating according to this simplified description would not work in the case where two computing devices behind the same NAT attempt to communicate with the same remote device. This paragraph and the next illustrate why this is the case and tell how actual NATs may deal with this situation. The third paragraph then describes the implications of this situation for the present invention. Returning to FIG. 1a, devices 100 and 102 share NAT 106. If these two devices both attempt to communicate with remote device 118, then the NAT will create a translation table such as that illustrated in FIG. 1c but with two entries: the first entry associates device 100's address (1.2.3) with device 118's address (12.9.7), and the second entry associates device 102's address (1.2.4) with device 118's address. However, these two entries are not sufficient to distinguish messages from device 118 intended for device 100 from messages intended for device 102. The messages arrive with a source address of (12.9.7), but as the translation table has two entries for that address, the NAT cannot determine where to send the message. Fortunately, modern communications protocols, such as IP, provide a way around this problem. IP messages may contain, in association with the source and destination addresses, source and destination fields called “ports.” Ports are often used to differentiate messages intended for separate processes running on a single computing device. A NAT may leave the port fields unaltered in messages passing through it (but see the next paragraph), and this allows the NAT to take advantage of ports to distinguish traffic intended for the two computing devices. For example, if device 100 specifies port 12 and device 102 specifies port 34, then the NAT simply extends the entries in the translation table to include these port numbers. When device 118 sends a message addressed to the NAT's public address, port 12, the NAT consults the translation table and sends the message to device 100. Thus, a NAT relies on port numbers to allow multiple devices behind it to communicate with the same remote device.

However, a problem arises if computing devices 100 and 102 choose to use the same port number. If the NAT 106 used that port number unaltered, then it would have no way to distinguish messages from device 118 intended for device 100 from messages intended for device 102. When necessary to solve this problem of overlapping ports, the NAT translates port numbers in the messages. This is termed “Port Address Translation” (PAT). If devices 100 and 102 both choose to use port 12 when communicating with remote device 118, then the NAT may translate the port number in device 100's messages to port 45. (This is reflected in the translation table entry.) Thus, remote device 118 sends messages intended for device 100 addressed to the NAT's public address, port 45, and sends messages intended for device 102 to the NAT's public address, port 12. In this manner, PAT solves the problem of overlapping ports.

In so doing, however, PAT creates a problem for the present invention. From the above discussion, it follows that a hole through a NAT is specific to the port used in the hole-punching message, whether that port is the one chosen by computing device 100 when it punches the hole or is a port chosen by the NAT practicing PAT. From this, it follows that if the present invention is to work, the remote device 118 must know the port associated with the hole. This in turn depends upon device 100's ability to communicate its chosen port to device 118. (The directory service of FIG. 6 may be used for this purpose, or the port may be communicated to device 118 in the hole-punching message itself. In the latter case, unlike in the example of FIG. 3, it is important that the hole-punching message actually reach device 118.) However, if the port is not the one chosen by device 100, that device is unaware of the port and cannot communicate the port to device 118. Thus, PAT disrupts the scheme of the present invention as disclosed so far. A solution is for device 100 to randomly choose a port for its messages. If that port is not already in use at the NAT, most NATs will not alter it. If, on the other hand, the NAT does change the port, then device 100 cannot tell its value to the device 118, and the hole will go unused. Device 100 may notice this, for example, by timing out without receiving any messages from device 118, and attempt another port. If there are not too many devices behind the NAT, this method should produce a usable port after, at most, a few attempts.

In view of the many possible embodiments to which the principles of this invention may be applied, it should be recognized that the embodiments described herein with respect to the drawing figures are meant to be illustrative only and should not be taken as limiting the scope of the invention. Therefore, the invention as described herein contemplates all such embodiments as may come within the scope of the following claims and equivalents thereof.

We claim:

1. A method for a first computing device to enable a second computing device to initiate a traffic flow with the first computing device, the method comprising:
formulating a message addressed for delivery to the second computing device; and
sending the message addressed for delivery to the second computing device.

2. The method of claim 1 wherein formulating a message comprises writing a public address of the second computing device into the message.

3. The method of claim 1 wherein formulating a message comprises writing a public address of a Network Address Translator (NAT) into the message, and wherein the second computing device is behind the NAT.

4. The method of claim 1 wherein formulating a message comprises writing a NULL content field into the message.

5. The method of claim 1 further comprising:
setting a timer associated with the sending step; and
upon expiration of the timer, sending a follow-up message addressed for delivery to the second computing device.

6. The method of claim 5 wherein a delay of the timer depends upon a type of a communications protocol used in the sending step.

7. The method of claim 1 further comprising:
before formulating the message, discovering an identity of the second computing device as a device with which the first computing device wishes to communicate.

8. The method of claim 7 wherein discovering comprises identifying the first computing device and identifying a type of communication in which the first computing device wishes to participate.

9. The method of claim 1 further comprising:
choosing a port number;
associating the chosen port number with the message; and
communicating the chosen port number to the second computing device.

10. The method of claim 9 further comprising:
setting a timer associated with the sending step; and
upon expiration of the timer, choosing a second port number, associating the second port number with a follow-up message, communicating the second port number to the second computing device, and sending the follow-up message addressed for delivery to the second computing device.

11. A computer-readable medium having instructions for performing the method of claim 1.

12. A method for a directory service to facilitate direct communications between a first computing device and a second computing device, the method comprising:
receiving from the first computing device a first identification of the second computing device as a device with which the first computing device wishes to communicate;
identifying the first computing device to the second computing device as a device wishing to communicate with the second computing device;
receiving from the second computing device a second identification of the first computing device as a device with which the second computing device wishes to communicate; and
identifying the second computing device to the first computing device as a device wishing to communicate with the first computing device.

13. The method of claim 12 wherein identifying the first computing device to the second computing device comprises sending a port number to be used in communicating with the first computing device.

14. The method of claim 12 wherein identifying the second computing device to the first computing device comprises sending a public network address of the second computing device.

15. The method of claim 12 wherein identifying the second computing device to the first computing device comprises sending a public network address of a NAT behind which lies the second computing device.

16. A computer-readable medium having instructions for performing the method of claim 12.

17. A method for a first computing device to enable a second computing device to initiate a traffic flow with the first computing device, the method comprising:
identifying to a directory service the second computing device as a device with which the first computing device wishes to communicate;
receiving from the directory service an identification of the second computing device as a device wishing to communicate with the first computing device;
formulating a message addressed for delivery to the second computing device; and
sending the message addressed for delivery to the second computing device.

18. The method of claim 17 wherein receiving an identification of the second computing device comprises receiving a public network address of the second computing device.

19. The method of claim 17 wherein receiving an identification of the second computing device comprises receiving a public network address of a NAT behind which lies the second computing device.

20. The method of claim 17 wherein formulating a message comprises writing a public address of the second computing device into the message.

21. The method of claim 17 wherein formulating a message comprises writing a public address of a NAT into the message, and wherein the second computing device is behind the NAT.

22. The method of claim 17 wherein formulating a message comprises writing a NULL content field into the message.

23. The method of claim 17 further comprising:
setting a timer associated with the sending step; and
upon expiration of the timer, sending a follow-up message addressed for delivery to the second computing device.

24. The method of claim 23 wherein a delay of the timer depends upon a type of a communications protocol used in the sending step.

25. The method of claim 17 further comprising:
choosing a port number;
associating the chosen port number with the message; and
communicating the chosen port number to the second computing device.

26. The method of claim 25 further comprising:
setting a timer associated with the sending step; and
upon expiration of the timer, choosing a second port number, associating the second port number with a follow-up message, communicating the second port number to the second computing device, and sending the follow-up message addressed for delivery to the second computing device.

27. A computer-readable medium having instructions for performing the method of claim 17.
